(19) United States
(12) Patent Application Publication
(10) Pub. No.: US 2012/0250206 A1
(43) Pub. Date: Oct. 4, 2012

(54) COMPACT RESIDUAL CURRENT BREAKER WITH OVERCURRENT PROTECTION

(75) Inventors: Jorge Juan Bonilla, Madrid (ES); Javier Gomez Martin, Humanes de Madrid (ES); Manuel Meana Alcon, Madrid (ES)

(73) Assignee: GENERAL ELECTRIC COMPANY, Schenectady, NY (US)

(21) Appl. No.: 13/075,530

(22) Filed: Mar. 30, 2011

(51) Int. Cl. H02H 3/08

(52) U.S. Cl. 361/102

(57) ABSTRACT

A single-module circuit breaker includes a first longitudinal portion, a second longitudinal portion, and a third longitudinal portion proximate the first and second longitudinal portions. The first longitudinal portion includes overcurrent detection componentry configured to detect an overcurrent condition. The second longitudinal portion includes leakage current detection componentry configured to detect a leakage current condition. The third longitudinal portion includes a contact mechanism, a first conduction path, and a second conduction path, and the contact mechanism is configured to disrupt the first and second conduction paths in response to at least one of the overcurrent condition and the leakage current condition.

### BACKGROUND OF THE INVENTION

The subject matter disclosed herein relates to current breakers, and in particular, to compact residual current breaker devices with overcurrent and leakage current protection.

### BRIEF DESCRIPTION OF THE INVENTION

According to one aspect of the invention, a single-module circuit breaker includes a first longitudinal portion, a second longitudinal portion, and a third longitudinal portion proximate the first and second longitudinal portions. The first longitudinal portion includes overcurrent detection componentry configured to detect an overcurrent condition. The second longitudinal portion includes leakage current detection componentry configured to detect a leakage current condition. The third longitudinal portion includes a contact mechanism, a first conduction path, and a second conduction path, and the contact mechanism is configured to disrupt the first and second conduction paths in response to at least one of the overcurrent condition and the leakage current condition.

According to another aspect of the invention, a single module circuit breaker includes overcurrent detection componentry configured to detect an overcurrent condition, a contact mechanism in mechanical communication with the overcurrent detection circuitry, and leakage current detection componentry in mechanical communication with the contact mechanism and configured to detect a leakage current condition. The contact mechanism is configured to open in response to at least one of the overcurrent condition and the leakage current condition.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a perspective view of a single pole plus neutral residual circuit breaker, according to an example embodiment;

FIG. 2 depicts a cut-away view of a first face of a single pole plus neutral residual circuit breaker, according to an example embodiment;

FIG. 3 depicts a cut-away view of a second face of a single pole plus neutral residual circuit breaker, according to an example embodiment;

FIG. 4 depicts a cut-away perspective view of a first face of a single pole plus neutral residual circuit breaker, according to an example embodiment;

FIG. 5 depicts a cut-away perspective view of a second face of a single pole plus neutral residual circuit breaker, according to an example embodiment;

FIG. 6 depicts a perspective view of a single pole circuit breaker, according to an example embodiment; and

FIG. 7 depicts a compacted core of a single pole plus neutral residual circuit breaker, according to an example embodiment.

The detailed description explains embodiments of the invention, together with advantages and features, by way of example with reference to the drawings.

### DETAILED DESCRIPTION OF THE INVENTION

Generally, a residual-current device (RCD) is an electrical wiring device that severs a circuit if an electric current is not balanced between an energized conductor (i.e., single pole conduction path) and a neutral conduction path. Such an imbalance may be caused by current leakage (e.g., Earth leakage) through the body of a person who is grounded and accidentally touching an energized portion of a circuit with RCD protection. Thus RCDs provide leakage current protection, absent overcurrent protection. Thus, conventional RCDs are physically separate from overcurrent protection devices (e.g., circuit breakers), and often require substantially additional physical space either through being connected serially to a device, or within the device, intended to be protected, or alongside the overcurrent protection devices.

However, example embodiments of the present invention provide novel arrangements of conduction paths within a circuit breaker and compacted RCD components which, when arranged according to the illustrations provided, allow both overcurrent protection and leakage current detection within a single module housing.

An example embodiment of the present invention provides a single pole plus neutral residual circuit breaker within a single module (e.g., 1W) housing. Example embodiments make efficient use of the internal dimensions of the single module housing to accommodate both Residual Current Detection (RCD) portions and Micro-Circuit Breaker (MCB) portions to provide a single pole plus neutral residual circuit breaker with leakage current detection. Example embodiments include circuit breakers having a housing, a circuit breaker disposed within the housing such that a MCB portion of the circuit breaker is accommodated within a first portion of the housing, and a RCD portion of the breaker is accommodated within the second portion of the housing. The first portion of the housing is situated at a first longitudinal end of the housing and the second portion is situated at a second longitudinal end of the housing.

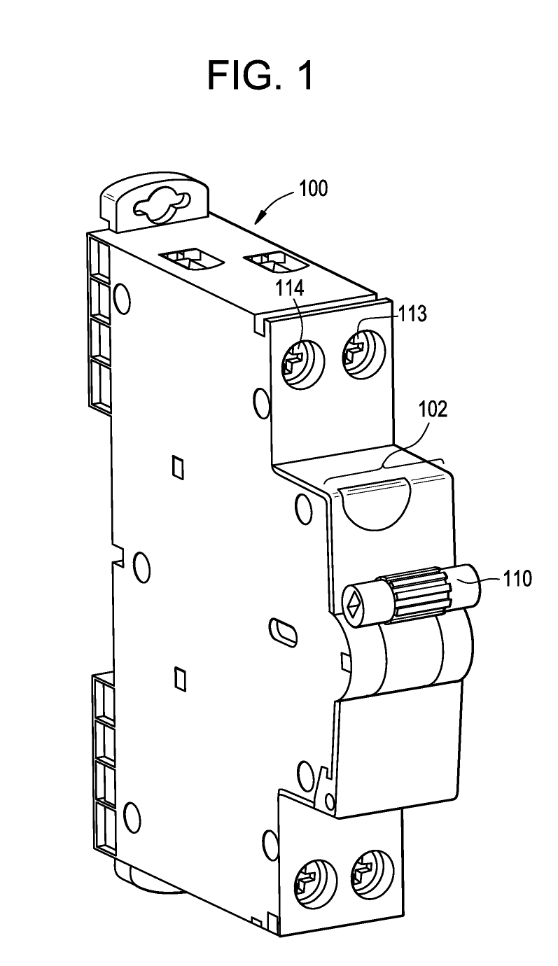

Referring now to FIG. 1, a perspective view of a single pole plus neutral residual circuit breaker 100 having a toggle 110 is depicted. As illustrated, the circuit breaker 100 includes both single pole and neutral conduction paths.

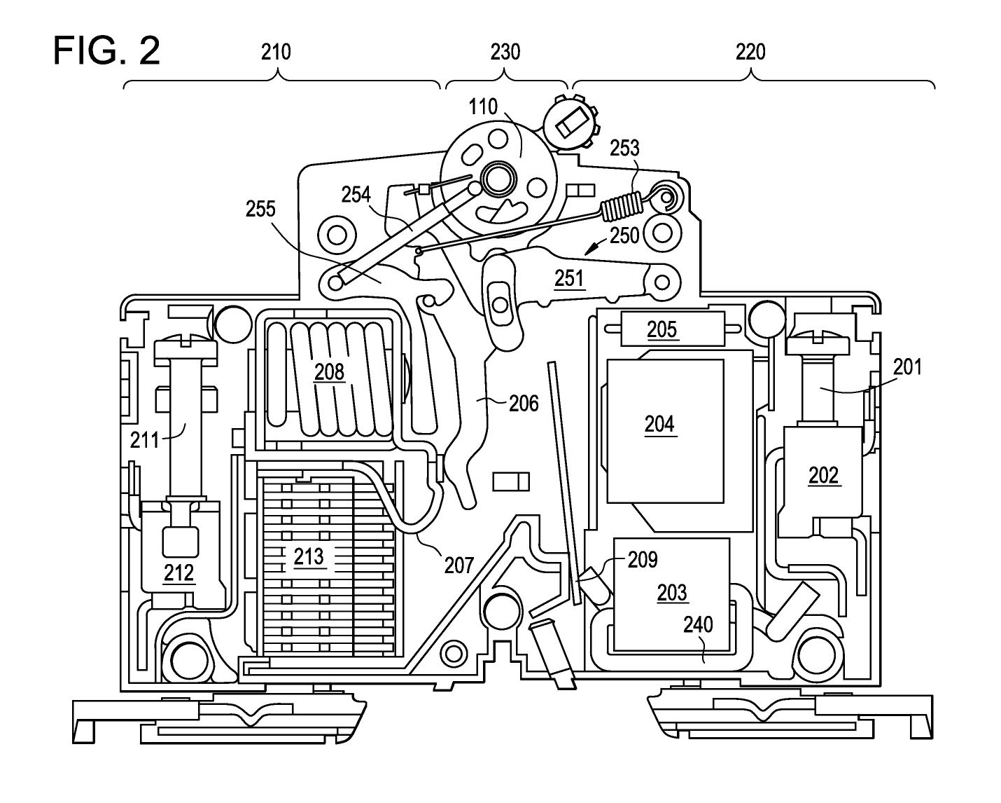

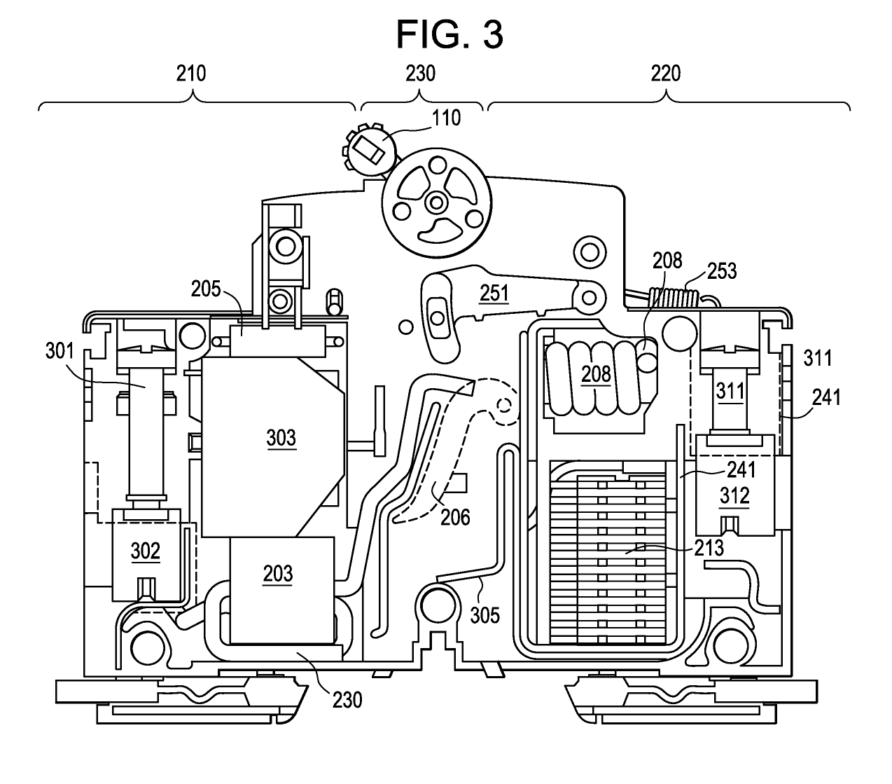

A single pole module housing 102 of the circuit breaker 100 has envelope dimensions that are the same as standardized single-pole circuit breakers, such as 18 millimeters wide in Europe and 0.75 inches wide in the US, also herein referred to as a 1W width, for example. Hereinafter, a more detailed description of the novel arrangement of typical circuit breaker components within a single module circuit breaker housing is provided with reference to FIGS. 2-3.

FIG. 2 depicts a cut-away view of a first face of a single pole plus neutral residual circuit breaker 100, according to an example embodiment. The first face of the circuit breaker (not illustrated in FIG. 1) includes a first portion 210 and second portion 220 of the housing 102. The first portion 210 includes the MCB components of the circuit breaker. The second portion 220 includes the residual current device RCD components of the circuit breaker. Further, a third portion 230 includes contact mechanism components including fixed and mobile contacts, bimetallic strip, and toggle components. Thus, according to example embodiments, a compacted single pole plus neutral residual circuit breaker includes a MCB components portion 210, a contact mechanism component portion 230 proximate the MCB components portion 210, and an RCD components portion 230 proximate the contact mechanism components portion 220.

Referring now to FIG. 2, a cut away view of the circuit breaker 100 is depicted. The components in FIG. 2 define a portion of the circuit breaker 100, and a portion of single pole 114 of the circuit breaker 100. The single pole 114 of the circuit breaker 100 is configured to carry and limit current flowing through the circuit breaker 100, for example, through tripping of the circuit breaker 100. In general, the single pole 114 may be configured to carry and limit a single phase current of an AC system.

As illustrated, the circuit breaker 100 includes clamp 201 and contact 202 within the second portion 220 of the circuit breaker 100. The contact 202 provides for a conduction path for the single pole 114 to components within the circuit breaker 100. The circuit breaker 100 further includes core 203 disposed within the second portion 220. The winding 240 about the core 203 provides a conduction path for the single pole 114 of the circuit breaker 100.

The circuit breaker 100 further includes circuit board (e.g., printed circuit board, PCB) 204 and resistor 205 disposed within the second portion 220. The PCB 204 may include circuit components disposed to control a tripping relay of the circuit breaker, wherein the tripping relay is configured to trip the circuit breaker 100 in response to predetermined or desired imbalance associated with a leakage current (illustrated in FIG. 3). The circuit breaker 100 may further include thermal protection strip 209 in communication with the winding 240.

The circuit breaker 100 further includes mobile contact mechanism 206 in mechanical communication with strip 209, and arranged to rest on support 207. If the strip 209 exceeds a threshold temperature which is based upon the material-make-up of the strip, the strip 209 disturbs the mobile contact mechanism 206 thereby severing electrical communication through disruption of the current path at mobile contact 304 (illustrated in FIG. 3).

The circuit breaker 100 further includes coil 208 in communication with the mobile contact 206 (illustrated in FIG. 2), which also provides a portion of the conduction path. The coil 208 is disposed to generate a signal indicative of the current carried in the conduction path to determine if the current threshold is exceeded. Thus, the coil 208 provides overcurrent detection while the core 203 provides leakage current detection.

The circuit breaker 100 further includes arc extinction portion 213 in communication with fixed contact 207 (illustrated in FIG. 2). The arc extinction portion 213 is disposed to extinguish, prevent, or reduce an electrical arc which may form due to separation of mobile contact 206 and fixed contact 207.

With regards to separation of mobile contact 206 and fixed contact 207, it is submitted that mechanical linkages 250 are provided which “trip” or “set” the circuit breaker 100, and also provide separation of mobile contact 206 and fixed contact 207 during an overcurrent event. The linkage 254 mechanically links the toggle 110 with the mobile contact 206 through interim linkage 255. The tensile spring 253 provides for force between the interim linkage 255 and the mobile contact 206 such that contact separation occurs if the toggle 110 is moved into an “off position” (it is noted that an “on position” is shown for clarity). The tripping linkage 251 is also in mechanical communication with mobile contact 206 and fixed contact 207 and provides for contact separation in response to an overcurrent event. The tripping linkage 251 is also in mechanical communication with tripping relay 303 (illustrated in FIG. 3). With regards to separation of mobile contact 206 and fixed contact 207 in response to leakage current detection above desired levels, it is submitted that mechanical linkages 250 provide separation of mobile contact 304 and fixed contact 305 in response to mechanical action of the tripping relay 303.

Finally, the circuit breaker 100 includes neutral clamp 301 and contact 302 within the first portion 210 of the circuit breaker 100. The neutral contact 302 provides for an additional conduction path for the neutral pole 113 to communicate with an external connection from the circuit breaker 100.

Hereinafter, the second face of the circuit breaker 100 is described in detail.

FIG. 3 depicts a cut-away view of a second face of a single pole plus neutral residual circuit breaker, according to an example embodiment. The second face of the circuit breaker includes a first portion 210 and second portion 220 of the housing 102. The first portion 210 includes the MCB portions of the circuit breaker. The second portion 220 includes the RCD portions of the circuit breaker.

Referring now to FIG. 3, a cut away view of the circuit breaker 100 is depicted. The components in FIG. 3 define a portion of neutral pole of the circuit breaker 100, and a portion of the single pole of the circuit breaker 100.

As illustrated, the circuit breaker 100 includes single pole clamp 301 and single pole contact 302 within the second portion 220 of the circuit breaker 100. The single pole contact 302 provides for a conduction path for the single pole to components within the circuit breaker 100. The circuit breaker 100 further includes core 203 disposed within the second portion 220. The second winding 230 about the core 203 provides a neutral conduction path for the neutral pole of the circuit breaker 100.

The circuit breaker 100 further includes tripping relay 303 disposed within the second portion 220. The tripping relay 303 may be controlled through PCB 204 (illustrated in FIG. 2).

Returning to the second winding 230, the circuit breaker 100 further includes mobile contact 304 in communication with the second winding 230. Further, the mobile contact 304 may be in severable communication with fixed contact 305. The mobile contact 304 may also provide a portion of the conduction path. Also, the fixed contact 305 may also provide a portion of conduction path. If the current carried within conduction path exceeds a given or desired threshold, the mobile contact 304 separates from fixed contact 305 thereby severing electrical communication between the mobile contact 304 and the fixed contact 305.

With regards to separation of mobile contact 304 and fixed contact 305, it is submitted that mechanical linkages 250 (FIG. 2) are provided which “trip” or “set” the circuit breaker 100, and also provide separation of mobile contact 304 and fixed contact 305 during an overcurrent event. For example, the mobile contact 304 may be in mechanical communication with the mechanical linkages 250 such that tripping may occur at substantially the same time as the tripping described above with regards to FIG. 2.

Finally, the circuit breaker 100 (see FIG. 3) includes neutral pole clamp 311 and contact 312 within the first portion 210 of the circuit breaker 100. The neutral pole contact 312 provides for the conduction path 241 for the neutral pole to communicate with an external connection from the circuit breaker 100.

Although described above as including particular single pole and neutral clamps/terminals and conduction paths on particular sides of the circuit breaker 100, it should be understood that the orientation and electrical connections to these clamps/terminals and conduction paths may be altered relatively easily according to any desired implementation. For example, the neutral clamps and conduction path noted above may be swapped with associated single pole clamps and conduction path through manipulation of connections to the clamps. For example, as the core 203 is disposed to detect an imbalance which results from leakage current, it is not necessary for either the primary or secondary windings 230 and 240 to be fixed as neutral or single pole conduction paths. Thus, example embodiments should not be limited to the particular orientation of each clamp and conduction path shown, but should include any suitable modification which offers substantially similar operation including overcurrent detection at a first longitudinal portion and leakage current detection at a second longitudinal portion of the circuit breaker 100.

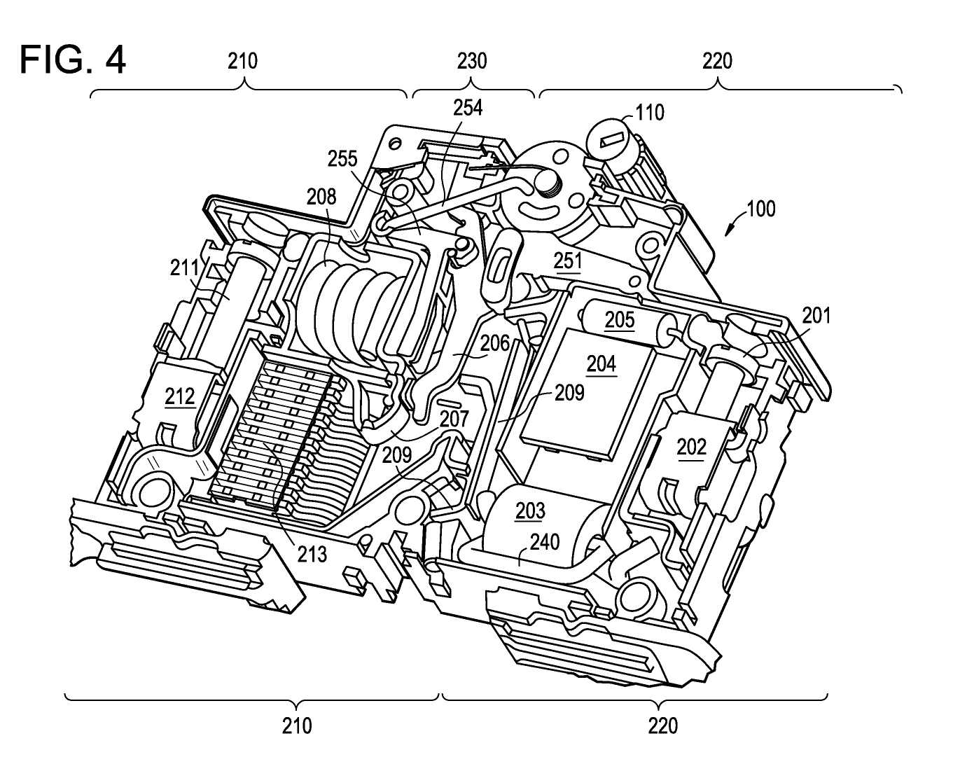

In order to better understand the novel geometry described above, perspective cut-away views illustrated in FIGS. 4-6 are described in detail below.

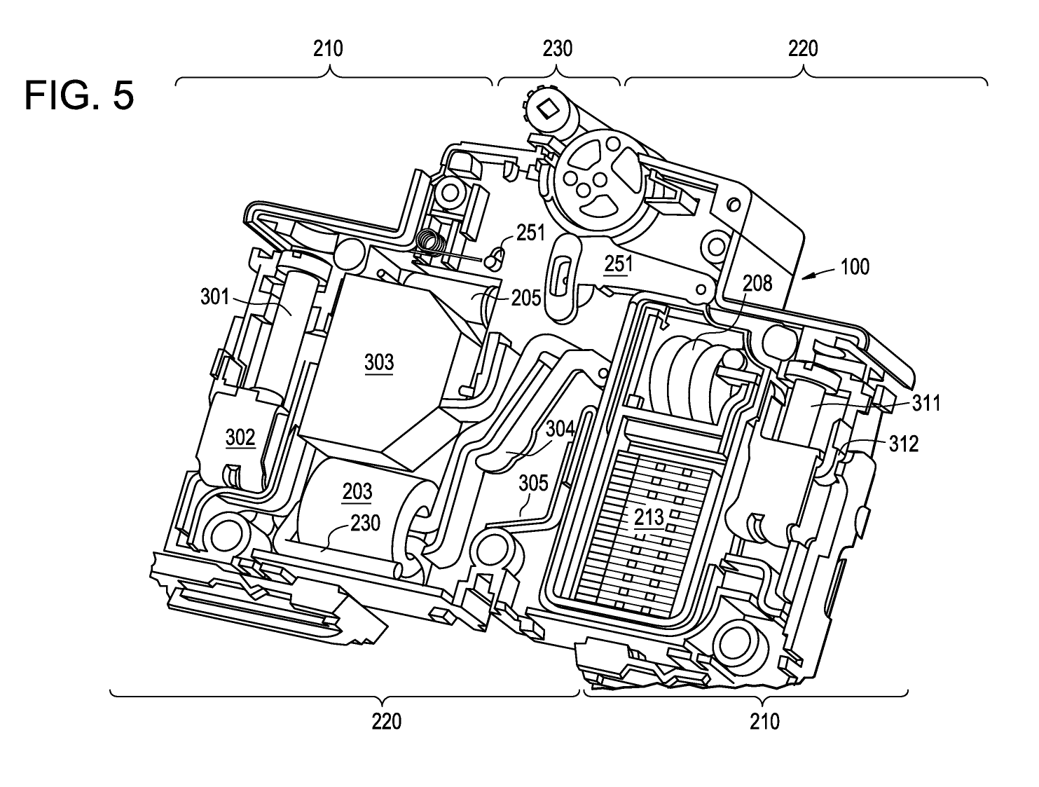

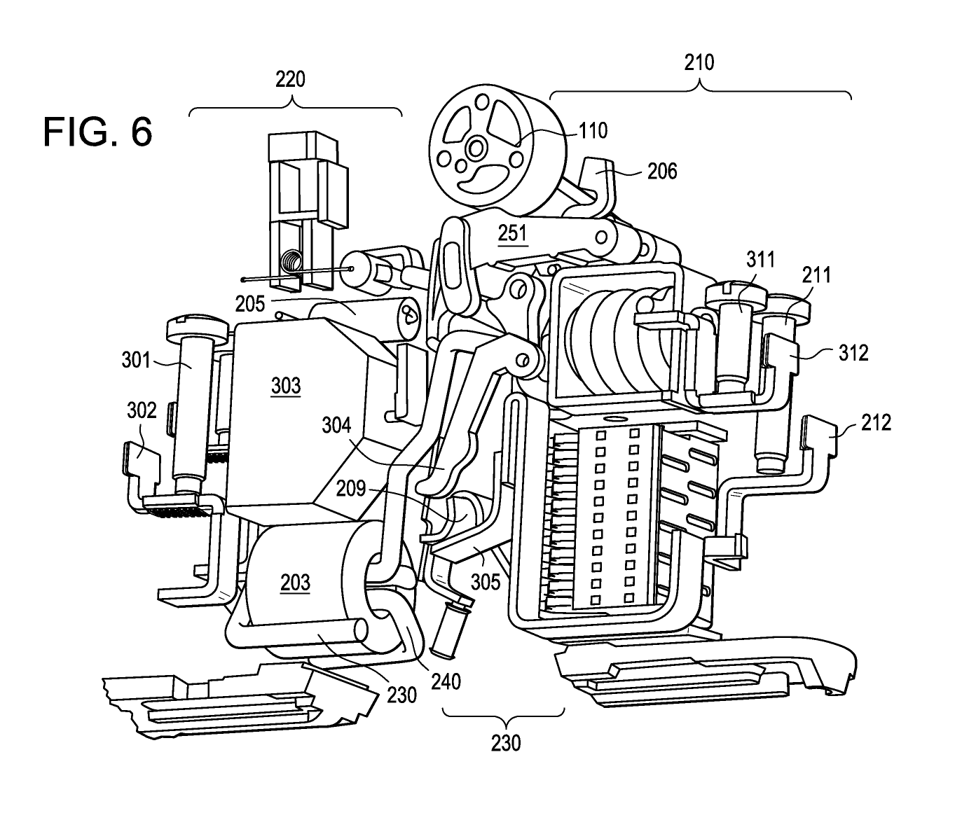

FIGS. 5-6 illustrate cut-away perspective views of the circuit breaker 100, according to an example embodiment. As illustrated, the second portion 220 of the circuit breaker 100 includes the RCD components configured to detect leakage current associated with the circuit breaker 100. Further, the first longitudinal portion includes the MCB components configured to detect overcurrent conditions. Further, the third longitudinal portion 230, proximate both the first and second longitudinal portions 210 and 220, includes contact mechanism components configured to trip and/or open/close the circuit breaker 100 in response to an overcurrent condition or current imbalance (i.e., leakage current condition).

As described above with regards to FIGS. 2-6, conduction paths of the circuit breaker 100 are arranged to allow arrangement of both MCB and RCD components within a single module housing. Through intelligent routing of these conduction paths, both the single pole and neutral pole of the circuit breaker 100 may be included in a single module of width 1W while also providing leakage current detection. Both micro circuit breaker components, contact mechanism components, and residual current device components are distributed across three longitudinal portions, allowing tripping of the circuit breaker from both the MCB components and RCD components though the same contact mechanism, thereby saving space. Thus, example embodiments provide a single module circuit breaker configured to provide both overcurrent and leakage current protection within a single module of width 1W.

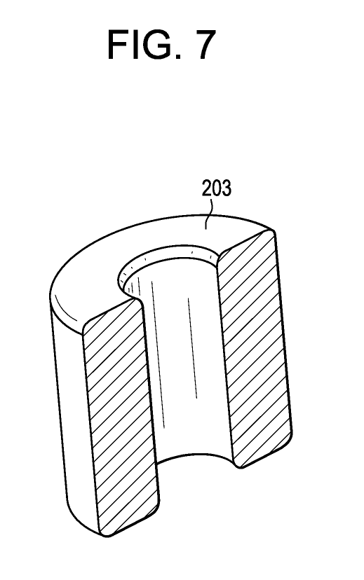

FIG. 7 depicts a compacted core of a single pole plus neutral residual circuit breaker, according to an example embodiment. The compacted core 203 may be arranged within the second portion 220 of the circuit breaker such that the PCB 204 and the trip relay 303 may be arranged in the second portion 220. Primary and secondary windings are arranged around and within the compacted core to facilitate current-imbalance detection through the PCB. In the event of current imbalance above a predetermined or desired threshold, the PCB provides, to the tripping relay, a signal indicative of the condition. In response to the signal, the tripping relay disturbs the contact mechanism components of the third longitudinal portion 230 of the circuit breaker thereby providing leakage current protection.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A single-module circuit breaker comprising:
a first longitudinal portion, wherein the first longitudinal portion includes:
overcurrent detection componentry configured to detect an overcurrent condition;
a second longitudinal portion, wherein the second longitudinal portion includes:
leakage current detection componentry configured to detect a leakage current condition; and
a third longitudinal portion proximate the first longitudinal portion and the second longitudinal portion, wherein the third longitudinal portion includes:
a contact mechanism,
a first conduction path, and
a second conduction path;
wherein the contact mechanism is configured to disrupt the first and second conduction paths in response to at least one of the overcurrent condition and the leakage current condition.

2. The circuit breaker of claim 1, wherein the overcurrent detection componentry includes a magnetic coil configured to detect the overcurrent condition.

3. The circuit breaker of claim 2, wherein the overcurrent detection componentry further includes an arc extinguishing device proximate to magnetic coil and the contact mechanism, and configured to reduce an arc associated with the contact mechanism.

4. The circuit breaker of claim 1, wherein the first conduction path and the second conduction path are independent conduction paths, and wherein the leakage current detection componentry is configured to detect a current imbalance between the first conduction path and the second conduction path.

5. The circuit breaker of claim 1, wherein the leakage current detection componentry comprises:
a compacted magnetic core;
a primary winding arranged in magnetic communication with the compacted magnetic core, the primary winding being associated with the first conduction path;
a secondary winding arranged in magnetic communication with the compacted core, the secondary winding being associated with the second conduction path; and
a resistor in electrical communication with the primary winding.

6. The circuit breaker of claim 5, wherein the leakage detection componentry further comprises a printed circuit board, wherein the printed circuit board comprises leakage detection circuitry in electrical communication with the resistor, and wherein the leakage detection circuitry is configured to determine if a current imbalance exists between the primary and secondary windings.

7. The circuit breaker of claim 6, wherein the leakage detection componentry further comprises a tripping relay in communication with the leakage detection circuitry, and wherein the tripping relay is configured to trip the contact mechanism in response to a leakage current condition signal provided from the leakage detection circuitry.

8. The circuit breaker of claim 1, further comprising a thermal protection device proximate and in mechanical communication with the contact mechanism.

9. The circuit breaker of claim 8, wherein the thermal protection device comprises:
a bimetallic strip disposed within the third longitudinal portion, the bimetallic strip responsive to excessive current flow through the first conduction path and configured to initiate opening of the circuit breaker.

10. The circuit breaker of claim 1, wherein;
the first longitudinal portion, the second longitudinal portion, and the third longitudinal portion are of substantially equal width.

11. A single module circuit breaker comprising:
overcurrent detection componentry configured to detect an overcurrent condition;
a contact mechanism in mechanical communication with the overcurrent detection circuitry; and
leakage current detection componentry in mechanical communication with the contact mechanism and configured to detect a leakage current condition;
wherein the contact mechanism is configured to open in response to at least one of the overcurrent condition and the leakage current condition.

12. The circuit breaker of claim 11, wherein the overcurrent detection componentry includes a magnetic coil configured to detect the overcurrent condition.

13. The circuit breaker of claim 12, wherein the overcurrent detection componentry further includes an arc extinguishing device proximate to magnetic coil and the contact mechanism, and configured to reduce an arc associated with the contact mechanism.

14. The circuit breaker of claim 11, wherein the leakage current detection componentry is configured to detect a current imbalance between independent contacts of the contact mechanism.

15. The circuit breaker of claim 11, wherein the leakage current detection componentry comprises:
a compacted magnetic core;
a primary winding arranged in magnetic communication with the compacted magnetic core and in electrical communication with the contact mechanism;
a secondary winding arranged in magnetic communication with the compacted core and in electrical communication with the contact mechanism; and
a resistor in electrical communication with the primary winding.

16. The circuit breaker of claim 15, wherein the leakage detection componentry further comprises a printed circuit board, wherein the printed circuit board comprises leakage detection circuitry in electrical communication with the resistor, and wherein the leakage detection circuitry is configured to determine if a current imbalance exists between the primary and secondary windings.

17. The circuit breaker of claim 16, wherein the leakage detection componentry further comprises a tripping relay in communication with the leakage detection circuitry, and wherein the tripping relay is configured to trip the contact mechanism in response to a leakage current condition signal provided from the leakage detection circuitry.

18. The circuit breaker of claim 11, further comprising a thermal protection device proximate and in mechanical communication with the contact mechanism.

19. The circuit breaker of claim 18, wherein the thermal protection device comprises:
a bimetallic strip responsive to excessive current flow through contacts of the contact mechanism and configured to initiate opening of the circuit breaker.
